(19) United States
(12) Patent Application Publication
(10) Pub. No.: US 2021/0176932 A1
(43) Pub. Date: Jun. 17, 2021

(54) SYSTEMS, METHODS, AND APPARATUS FOR AEROPONICS

(71) Applicant: Aero Root Systems Ltd., Surrey (CA)

(72) Inventors: Preet Pritpal Singh Atwal, Surrey, BC (CA); Christopher Gordon Stoner, Vancouver, BC (CA)

(73) Assignee: Aero Root Systems Ltd., Surrey, BC (CA)

(21) Appl. No.: 17/053,306

(22) PCT Filed: May 24, 2018
(86) PCT No.: PCT/CA2018/050605

§ 371 Date: Nov. 5, 2020

(51) Int. Cl. A01G 31/02

(52) U.S. Cl. CPC A01G 31/02

(57) ABSTRACT

Methods and systems for cooling plant roots in an aeroponics unit are disclosed. One such system includes a growing unit coupleable to a mist generator for delivering a mist within the growing unit. The growing unit includes two opposing side walls connected by a top wall, a base, a front wall and a back wall with plant receptacles on the front wall. A lower opening in one of the opposing side walls, the back wall, the front wall, or the base and an upper opening in one of the opposing side walls, the back wall, the front wall, or the top wall are shaped and positioned to allow a root cooling convection air current to form between the lower opening and the upper opening to cool plant roots by allowing ambient air to enter the enclosure through the lower opening and warmer air to exit through the upper opening.

### TECHNICAL FIELD

The present disclosure relates to aeroponics, and in particular, aeroponics plant growing units.

### BACKGROUND

Urban farming is a growing industry. Farms are being created in abandoned lots, roof tops, parking lots, and in buildings. Urban farming is a solution to the ecological impacts of transporting food and concentrating agriculture. However, the viability of urban farming depends on profitability.

Aeroponics has been touted as a solution to the limitations of traditional farming in urban settings. Aeroponics is an advanced form of hydroponics where plant roots are fed with a nutrient mist. The plant roots are suspended in air, in a dark chamber, and fed with a nutrient mist. Aeroponics is efficient in reducing the amount of water, nutrients, and time required to grow plants. Aeroponics also does not require soil, thereby lending itself for use in an urban environment.

There exists a continuing desire to advance and improve technology related to aeroponics.

### SUMMARY

According to one aspect, there is provided a growing unit coupleable to a mist generator for delivering a mist within the growing unit. The growing unit may include an enclosure formed by two opposing side walls connected by a top wall, a base, a front wall and a back wall. The growing unit also may also include a plant receptacle in the front wall for holding a plant. The plant receptacle may include an opening for allowing a bottom portion of a stem of the plant and roots of the plant into the enclosure. The growing unit may further include a lower opening in any one of the opposing side walls, the back wall, the front wall, or the base and an upper opening in any one of the opposing side walls, the back wall, the front wall, or the top wall. The lower opening and the upper opening may be shaped and positioned to allow a root cooling convection air current to form between the lower opening and the upper opening to cool plant roots within the enclosure by allowing ambient air to enter the enclosure through the lower opening and warmer air within the enclosure to exit through the upper opening.

According to another aspect, there is provided a plant growing system that may include a growing unit which may further include an enclosure formed by two opposing side walls connected by opposing front and back walls, a top wall, and a base. The growing unit may also include a first misting component coupled to the growing unit to provide a mist within the enclosure when the first misting component is in an operative state, a second misting component coupled to the growing unit to provide a mist within the enclosure when the second misting component is in an operative state, a sensor coupled to the growing unit for detecting a failure state of the first misting component, and a switch communicatively coupled to the sensor and coupled to the second misting component for switching the second misting component to an operative state upon detection by the sensor of the failure state of the first misting component.

The growing unit may also include a plant receptacle in the front wall for holding a plant. The plant receptacle may include an opening for allowing a bottom portion of a stem of the plant and roots of the plant into the enclosure. The growing unit may also include a lower opening in any one of the opposing side walls, the back wall, the front wall, or the bottom wall and an upper opening in any one of the opposing side walls, the back wall, the front wall, or the top wall. The lower opening and the upper opening may be shaped and positioned to allow a root cooling convection air current to form between the lower opening and the upper opening to cool plant roots within the enclosure by allowing ambient air to enter the enclosure through the lower opening and warmer air within the enclosure to exit through the upper opening.

According to another aspect, there is provided a method for growing a plant in an aeroponics growing unit. The method may include providing a nutrient solution mist inside the aeroponics growing unit using a first misting component coupled to the aeroponics growing unit to provide nutrients and water to roots of the plant extending inside the aeroponics growing unit. The inside of the aeroponics growing unit may be an enclosure formed by a base, a back wall, a front wall, a top wall, and opposing side walls of the aeroponics growing unit. The method may also include generating a root cooling convection air current between a lower opening and an upper opening to cool plant roots within the enclosure by allowing ambient air to enter the enclosure through the lower opening and warmer air within the enclosure to exit through the upper opening. The lower opening may be positioned in any one of the opposing side walls, the back wall, the front wall, or the base and the upper opening is positioned in any one of the opposing side walls, the back wall, the front wall, or the top wall and the lower opening and the upper opening may be shaped and positioned to generate the root cooling convection air current.

The method may also include sensing a failure state of the first misting component using a sensor coupled to the aeroponics growing unit, switching a second misting component to an operative state using a switch communicatively coupled to the sensor and to the second misting component upon detection by the sensor of the failure state of the first misting component and providing a mist inside the aeroponics growing unit using the second misting unit.

### BRIEF DESCRIPTION OF THE DRAWINGS

In the accompanying drawings, which illustrate one or more example embodiments,

FIG. 1 is a block diagram of an aeroponics growing system, according to one embodiment;

FIG. 2 is a block diagram of an aeroponics growing system with redundancy according to one embodiment;

FIG. 3 is a schematic diagram of a growing unit with a convection air current for cooling plant roots, according to one embodiment;

FIG. 4 is a schematic diagram of a growing unit with a convection air current for cooling plant roots, according to another embodiment;

FIG. 5 is a perspective view of a growing unit according to one embodiment;

FIG. 6 is a perspective view of an A frame style growing unit according to one embodiment;

FIG. 7 is a perspective view of growing units daisy chained together according to one embodiment;

FIG. 8a is an exploded perspective view of the components of the growing unit of FIG. 5, according to one embodiment;

FIG. 8b is a side view of the modular racks of the embodiment shown in FIG. 8a;

FIG. 8c is a partial view of a side wall slot of the embodiment shown in FIG. 8a;

FIG. 9 shows modular racks for different planting surfaces according to one embodiment; and

FIG. 10 shows a method for growing plants using aeroponics according to one embodiment.

### DETAILED DESCRIPTION

Directional terms such as “top”, “bottom”, “upper”, “lower”, “left”, “right”, and “vertical” are used in the following description for the purpose of providing relative reference only, and are not intended to suggest any limitations on how any article is to be positioned during use, or to be mounted in an assembly or relative to an environment. Additionally, the term “couple” and variants of it such as “coupled”, “couples”, “coupling”, and “couplable” as used in this description are intended to include indirect and direct connections unless otherwise indicated. For example, if a first device is coupled to a second device, that coupling may be through a direct connection or through an indirect connection via other devices and connections. Similarly, if the first device is communicatively coupled to the second device, communication may be through a direct connection or through an indirect connection via other devices and connections. The term “couplable”, as used in the present disclosure, means that a first device is capable of being coupled to the second device. A first device that is communicatively couplable to a second device has the ability to communicatively couple with the second device but may not always be communicatively coupled.

The term application, as used in this document, refers to a set of instructions executable by a computer processor. The application may be a standalone application or it may be integrated within other applications and systems, such as a computer operating system. A computer, in the context of this document, refers to a device having a processor and a computer readable memory. The memory may be the processor's internal memory. The memory may comprise a separately embodied memory to which the processor has access—e.g. by suitable physical interface, suitable network interface and/or the like.

Aeroponics has seen increased use in agriculture, particularly in urban farming. While aeroponics may be efficient in reducing the amount of water, nutrients, and time required to grow plants, there may be some disadvantages with the current state of aeroponics as compared to hydroponics and soil farming. Some disadvantages may be related to reliability, affordability, maintenance, and creating and maintaining a desirable root zone environment.

The root zone environment in aeroponics is quite sensitive, particularly to temperature and nutrient mist droplet size. Preferred temperatures for the root zone environment are generally accepted as being between 10° C. and 25° C. Lower temperatures are favoured for increasing root surface area and photosynthetic response. The use of enclosed growing units in aeroponics may lead to trapped heat inside the growing units and higher root zone temperatures. Temperatures may further increase if pumps and misting generators are located within the growing unit.

Roots are also sensitive to droplet size. The inventor of the present disclosure has found that a droplet size of approximately 100 microns or less will result in more root surface area and droplet sizes between 30 and 100 microns are favourable for use in aeroponics systems. However, many aeroponics systems use misting generators with low pressure pumps that may not produce droplet sizes of 100 microns or less.

Aeroponics systems may also have reliability issues. A failure of the misting generator may cause root damage or plant death quicker in an aeroponics system where the roots are hanging in air and potentially drying out than in systems where the roots are not hanging in air to potentially dry out. Wear and tear on the misting generators, particularly high pressure misting generators, may lead to risk of frequent failures. Reliability issues may also lead to increased costs associated with aeroponics systems.

Many aeroponics systems also use artificial environments like artificial lighting or greenhouses. Additionally, many aeroponics systems are not portable. They may use fixed spaces and centralized delivery systems. The lack of portability may lead to rental fee abuses by property owners because the owner's of the systems are not able to easily move out. Special zoning requirements may also be in place for aeroponics systems. Many systems also do not optimize floor space. Outdoor aeroponics systems may also fail to make use of the solar cycle, with plants falling into shade as the cycle progresses.

The present disclosure provides aeroponics systems that use convection based cooling for the roots. Air inlets and outlets are provided in an enclosed growing apparatus. The air inlets and outlets may be positioned and sized to cause natural convection currents with ambient air (air from outside the growing unit) entering at a lower position of the growing unit. The warm, moist conditions inside the growing apparatus cause the air entering to begin warming. Warm air rises and exits from the outlet positioned somewhere near a top portion of the growing apparatus. The air entering and rising may create a cooling tower and cool the roots as it moves past the roots. Moisture evaporating from the roots may cause evaporative cooling. Additionally, the convection current may cool the mist. Having a pool of runoff nutrient or water close to the air inlet may also increase the cooling effect due to water evaporation and removal of heat from the pool.

The present disclosure also provides aeroponics systems that may increase reliability through the use of redundant mist generators. A failure of the first mist generator may cause the second generator to start, keeping the plant roots misted. Additionally, the present disclosure provides for aeroponics systems that are portable, modular, use vertical growing systems to increase floor space use and may be used indoors or outdoors. The use of vertical growing systems may allow for plants to be grown in a stacked fashion, increasing the amount of plants grown in a given space. Sloped growing surfaces may expose more plants to light than a non-sloped surface. With a non-sloped surface, higher positioned plants may cast shadows on lower positioned plants. Having sloped surfaces on both sides in an “A” frame configuration may further allow a user to take advantage of the sun cycle by increasing the number of plants exposed to sunlight and providing similar exposure time to sunlight for plants on either side of the A frame. In some cases, wheeled systems be used to allow movement of an aeroponics system to more desirable locations, such as locations with greater exposure to sunlight.

Portable systems with vertically sloped surfaces, convection based cooling, and built in redundancy may increase the profitability of aeroponics systems by decreasing costs and increasing plant growth.

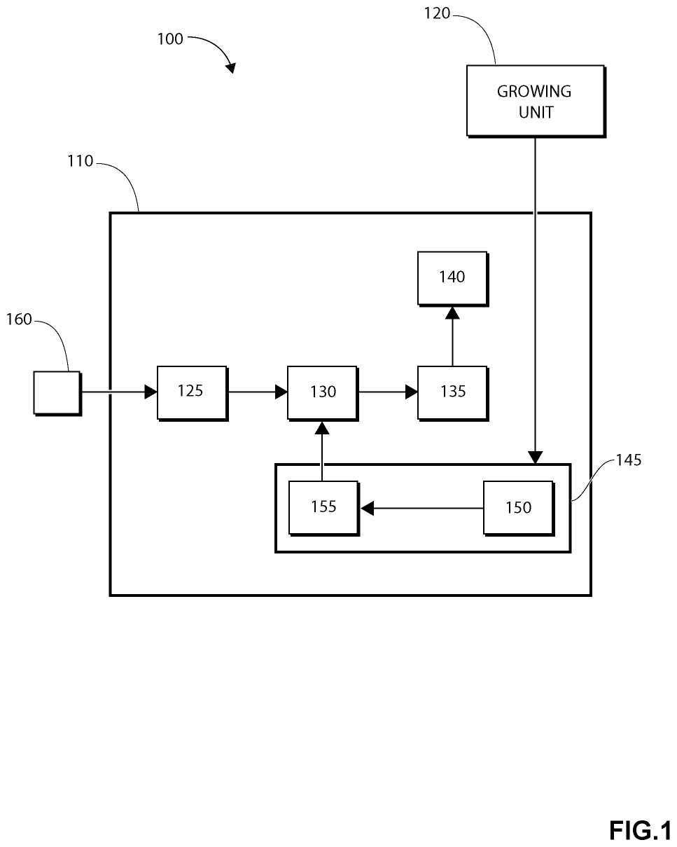

Aeroponics systems may generally use several coupled components. For example, an aeroponics system may comprise a nutrient handling system and a growing unit. Referring to FIG. 1, a block diagram of an embodiment of an aeroponics growing system 100 is shown. The aeroponics growing system 100 comprises a nutrient handling system 110 and a growing unit 120. The nutrient handling system 110 comprises several systems, including a nutrient conditioning system 125, a nutrient reservoir system 130, a nutrient supply filtration system 135, a nutrient delivery system 140 as well as a nutrient return system 145 which further comprises a nutrient return filtration system 150 and a nutrient return treatment system 155. Inputs 160, such as, for example, water, nutrients, and a pH buffer, may be mixed together as a nutrient solution and stored in the nutrient reservoir system 130.

The nutrient conditioning system 125 may be used for monitoring the nutrient reservoir system 130 and properties of the nutrient fluid and adjusting nutrient fluid properties. The nutrient conditioning system 125 may comprise or, in some embodiments, be communicatively coupled to sensors for monitoring various properties including, but not limited to, the fill level of the nutrient reservoir system 130, the pH level of the nutrient fluid, the concentration of nutrients present in the nutrient fluid, the temperature of the nutrient fluid, and the oxygen level of the nutrient fluid. The sensors may communicate data to a computer for analysis. The computer may, depending on the results, continue monitoring without taking any action or cause an action to be taken. For example, a temperature sensor may communicate the temperature of the nutrient fluid in the nutrient reservoir system 130 to the computer and the computer may run an application to determine if the temperature is within an acceptable temperature range. If the application determines that the temperature is within the acceptable range of temperatures, the computer may continue monitoring without taking any action.

If, however, the application determines that the temperature is below a lower threshold temperature value or above a higher threshold temperature value, the application may initiate an action. Any appropriate action may be initiated. For example, in some embodiments a user may be alerted. The user may then determine the correct course of action. In certain embodiments, automatic corrective actions may be initiated. For example, the nutrient conditioning system 125 or the nutrient reservoir system 130 may be coupled to a heater or a chiller to heat or chill the nutrient fluid. The application may have the computer communicate with the heater or chiller to heat or chill the nutrient fluid. The nutrient fluid may be heated or chilled as suitable. For example, the nutrient fluid may be chilled or heated for set periods of time. In some embodiments, a feedback loop may be used to heat or chill the nutrient fluid until a temperature reading within the acceptable range is achieved.

The nutrient conditioning system 125 and/or the nutrient reservoir system 130 may comprise or be coupled to other systems for taking automatic corrective actions as well. These systems may include, for example and without limitation, aerators and agitators for achieving and maintaining desired oxygen levels and a well-mixed nutrient fluid. Other systems may also include dispensers for dispensing any suitable materials. For example, there may be dispensers for nutrients, pH adjusters, and water. Any suitable type of dispenser may be used. For example, in some embodiments, a water dispenser may comprise a valve on a water line coupled to the main water supply for a building. In certain embodiments, the dispenser may comprise a storage tank coupled to the nutrient conditioning system 125 or the nutrient reservoir system 130. Sensors coupled to the storage tank may monitor the amount of materials in the storage tank so that a user may be alerted for replenishing the materials if they fall below a specified threshold amount.

In some embodiments, a system for taking a corrective action, such as a heater, may be coupled to its own computer and sensor. The computer may be dedicated for running a single system and in some embodiments, may be integrated with the system for taking corrective action. For example, the heater may have an integrated computer system (a processor and storage device) for analyzing temperature data from the sensor and activating the heater when the temperature readings are below a threshold value. In certain embodiments, additional systems may share a local computer. For example, a chiller may use the same computer as the heater described above.

In some embodiments, multiple systems may be controlled by one or more applications run by a central computer. The central computer may be a part of the nutrient conditioning system 125. In certain embodiments, the nutrient conditioning system may be communicatively coupled to a central computer used for running various systems of the aeroponics growing system 100.

Any of the computers discussed herein may comprise one or more processors or microprocessors, such as a central processing unit (CPU). The processor performs arithmetic calculations and control functions to execute software stored in a computer readable memory. The computer readable memory may be an internal memory, such as one or both of random access memory (RAM) and read only memory (ROM), and possibly additional memory. The additional memory may comprise, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory may be physically internal to the computer or external or both. The processor may retrieve items, such as applications and data lists, stored on the additional memory and move them to the internal memory, such as RAM, so that they may be executed or to perform operations on them.

A computer may also comprise other similar interfaces for allowing computer programs or other instructions to be loaded. Such interfaces may comprise, for example, a communications interface or transmitter that allows software and data to be transferred between the computer and external systems and networks. Examples of the communications interface comprise a modem, a network interface such as an Ethernet card, a wireless communication interface, or a serial or parallel communications port. Software and data transferred via the communications interface are in the form of signals which may be electronic, acoustic, electromagnetic, optical, or other signals capable of being received by the communications interface. Multiple interfaces, of course, may be provided on the computer.

In some embodiments, a computer may also comprise a display, a keyboard, pointing devices such as a mouse, and a graphical processing unit (GPU). The various components of the computer are coupled to one another either directly or indirectly by shared coupling to one or more suitable buses.

A sensor that may be communicatively coupled to the nutrient conditioning system 125, nutrient reservoir system 130, or more generally, to any part of the aeroponics growing system 100, may be pre-installed and integrated within any suitable physical structure of the aeroponics growing system 100. In some embodiments, the sensor may be retrofitted to the aeroponics growing system 100. A sensor may comprise a computer readable memory and a processor. In some embodiments, a sensor may use a computer readable memory and a processor of the aeroponics growing system 100. In certain embodiments, a sensing function of the sensor may be performed or implemented by a processor of the aeroponics growing system 100.

In some embodiments, the sensor may comprise multiple sensors. For example, the sensor may comprise multiple temperature sensors, such as thermocouples. The sensor may also comprise different types of sensors. For example, the sensor may comprise a thermocouple and a timer. As another example, the sensor may comprise a camera and a processor of the aeroponics growing system 100. The processor may provide, in this example, a timing function for the sensor.

Various types of sensors may be used in the aeroponics growing system 100 for measuring different properties of the aeroponics growing system 100. For example, any suitable types of sensors for measuring properties such as but not limited to flow rates, temperatures, weights, fluid levels, air pressure, fluid pressure, conductivity, electric current, density, solute concentrations, oxygen levels, pH levels and moisture levels may be used. An example of a commercially available monitor comprising a pH sensor, a temperature sensor and conductivity probes is the Bluelab™ Guardian Monitor Connect Inline. Conductivity probes may be useful for measuring solute levels in the nutrient solution.

An application may be used to process raw data from the sensor. In some embodiments, the application may be stored and executed by a computer readable memory and processor of the sensor. In certain embodiments, the sensor may communicate raw data to a processor of the aeroponics growing system 100 for processing by the application, which may be stored on a computer readable memory of the aeroponics growing system 100 that is not dedicated to the sensor.

Data processed by an application may be raw data or it may have gone through one or more processing steps. Any suitable application may be used. The application may compare the data to a set of parameters, which may also be stored on a computer readable memory coupled to the aeroponics growing system 100. The parameters may be threshold parameters that represent threshold conditions for identifying properties of the aeroponics growing system 100 that indicate that a corrective action may be desirable, such as, for example, heating the nutrient fluid. Any suitable sets of threshold parameters may be used. The sets of threshold parameters may be specific to the type of sensor coupled to the aeroponics growing system 100. In some embodiments, the threshold parameters may also be specific to the characteristics, such as size, of the particular growing unit being used. In certain embodiments, the threshold parameters may be at least partially based on the specific type of plant or plants being grown.

In some embodiments, conditioning may be performed manually by a user adding water, nutrients, or any other inputs to the nutrient reservoir system 130.

Any suitable reservoir may be used for the nutrient reservoir system 130. For example, any suitable container may be used to hold the nutrient fluid. The container may be covered in some embodiments and not covered in other embodiments. In some embodiments, the nutrient reservoir system may include a drum for holding the nutrient fluid. The nutrient reservoir system may be constructed of any suitable material, such as, without limitation, any suitable plastic, metal, composite or glass material. For example, the nutrient reservoir system may include a plastic drum or bin.

The nutrient reservoir system may be located outside the growing unit 120. In some embodiments, the nutrient reservoir system may be located inside the growing unit 120.

Referring again to FIG. 1, the nutrient fluid passes from the nutrient reservoir system 130 to the nutrient supply filtration system 135. The nutrient supply filtration system 135 may filter the nutrient fluid before the nutrient fluid passes through a mist generator and/or any pumps. Solid particles or material that may have entered the nutrient reservoir system 130 may be filtered out. Any suitable type of filter may be used. In some embodiments, a mechanical filter such as a mesh style filter may be used. For example, a strainer filter with a mesh for removing particles as small as 150 microns may be used. The filter may be installed at any suitable position between the nutrient reservoir system 130 and the mist generator.

In certain embodiments, the nutrient solution may also be disinfected to remove micro-organisms using ozone or ultraviolet light. In some embodiments, chlorine may be used to disinfect the nutrient solution. In these embodiments, the chlorine may be off-gassed (evaporated).

The nutrient fluid then passes from the nutrient supply filtration system 135 to the nutrient delivery system 140. The nutrient delivery system 140 may deliver nutrient fluid to the growing unit 120. The growing unit 120 may comprise an enclosure. Roots of a plant located outside of the enclosure may extend into the enclosure. In some embodiments, the nutrient delivery system 140 may comprise a mist generator for delivering nutrient fluid to the interior of the enclosure in the form of a mist.

A mist generator may comprise a misting component coupled to a delivery component. Any suitable mist generator may be used. For example, in some embodiments, the mist generator may comprise a high pressure pump as the misting component coupled to one or more nozzles as the delivery component. In certain embodiments, the mist generator may comprise a low pressure pump coupled to one or more nozzles. In some embodiments, sprinklers using a gravity fed nutrient reservoir may act as the mist generator. In some embodiments, the mist generator may comprise an ultrasonic transducer as the misting component for causing the nutrient fluid to form a mist. A fan may be used to distribute the mist to the plant roots. Mist generators using air pressure to atomize the nutrient fluid may also be used in some embodiments. In certain embodiments, mechanical atmomization may be used.

In embodiments where the mist generator comprises a pump coupled to a nozzle, the pump may provide pressure both for moving nutrient fluid from the nutrient filtration system and to provide pressure to the nozzle for atomizing the nutrient fluid into a mist. In some embodiments, the pump may provide suction for moving nutrient fluid throughout the nutrient handling system 110. In certain embodiments, dedicated pumps for moving nutrient fluid and/or other fluids through different parts of the nutrient handling system 110 may be used.

Any suitable type of pump may be used as the misting component. In some embodiments, a pump capable of providing sufficient pressure to the nozzle to produce a droplet size of 100 microns or less may be used. For example, and without limitation, pumps such as a Permeate Pump from Aquatec™ may be used.

The misting generator may be positioned inside or outside the growing unit 120. In some embodiments, a misting generator may be positioned at the base of the growing unit 120.

In some embodiments, the nozzle may be located inside the growing unit 120. In certain embodiments, the nozzle may be located on an exterior portion of the growing unit 120 and may direct a mist to the inside of the growing unit 120 through an opening in a wall of the growing unit 120.

The nozzle may comprise one or more nozzles. In some embodiments, an array of nozzles may be used. The nozzles may be positioned at any suitable location inside or outside of the growing unit 120. For example, in some embodiments, the nozzle may be positioned at a bottom portion of the growing unit 120 so as to spray a mist upwards to the plant roots. In certain embodiments, the nozzle may be positioned at a top portion of the growing unit 120 so as to spray a mist downwards onto the plant roots. In some embodiments, nozzles may be positioned at various heights. For example, nozzles may be positioned at regular vertical intervals along a wall of the growing apparatus 120, such as and without limitation, a back wall of the growing apparatus 120. For example, several nozzles may be positioned in a row at each vertical height adjacent to plant roots. The nozzles may be connected in series such that nutrient flow enters at the bottom of the growing unit 120 and flows through piping supplying a series of nozzles along a bottom portion of the growing unit 120. The piping may then bend up and run horizontally at a second height supplying a series of nozzles along the second height before bending up and running back horizontally at a third height. Any suitable number of vertically separated rows may be used. The piping may supply nozzles arranged in rows at several heights, each row being adjacent to a row of plant roots.

In certain embodiments, nozzles may be supplied in a parallel piping arrangement. For example, a pipe from the misting component may split into several pipes, each pipe supplying one or more nozzles in the growing unit 120.

Any suitable type and model of nozzle may be used and different types and models of nozzles may be combined for use with the growing unit 120.

The nozzle may be coupled to the pump using any suitable piping. Flexible or rigid piping may be used. Additionally, any suitable types of connections and sealants for coupling the piping to the pump and the nozzles may be used. For example, in some embodiments, a flexible hose may be clamped to the pump at one end and to the nozzle at the other end. In certain embodiments, non-toxic or food-safe grade sealants may be used.

Any suitable length of piping may be used. In some embodiments, the nozzle may be positioned adjacent or close to the pump. In certain embodiments, the nozzle may be positioned at a longer distance from the pump. For example, a nozzle may be positioned at a top or upper portion of the growing unit 120 while the pump may be located at a bottom portion or even outside of the growing unit 120.

A failure of the nutrient delivery system 140 may result in damage to or death of plants. To reduce the possibility of the nutrient delivery system 140 failing, redundancy may be added to the nutrient delivery system 140. Redundancy may be in the form of additional or back-up misting components. In some embodiments, redundancy may include additional or back-up power systems.

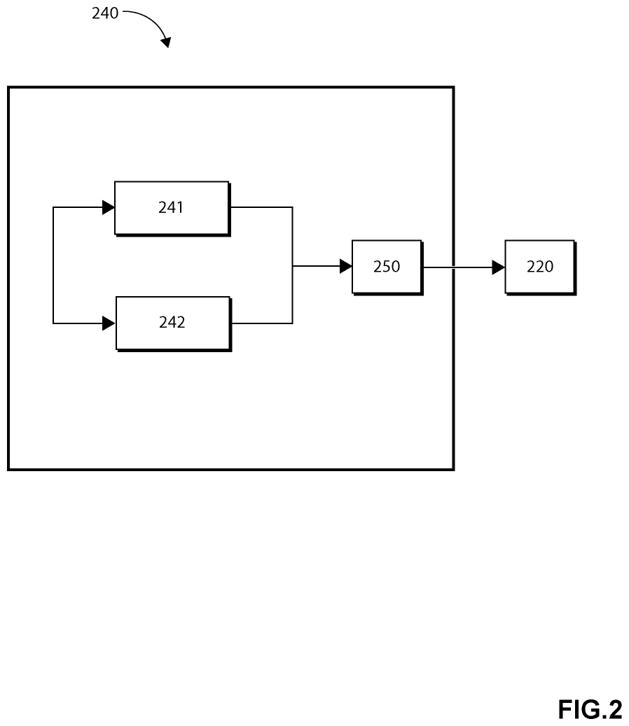

Referring to FIG. 2, a block diagram of an embodiment of a nutrient delivery system 240 with redundancy is shown. The nutrient delivery system 240 is coupled to a growing unit 220 into which the nutrient delivery system 240 delivers a nutrient mist. The growing unit 220 may comprise an enclosure formed by two opposing side walls connected by opposing front and back walls, a top wall and a base. In some embodiments, plants may be grown at plant receptacles on, for example, the top wall or the front wall. Roots from the plants may extend into the enclosure. The nutrient delivery system 240 may comprise two misting components, the first or principle misting component 241 and the second or secondary misting component 242. In some embodiments, more than two misting components may be used.

The multiple misting components may be connected in parallel between a nutrient reservoir system and the growing unit 220, as shown in in FIG. 2, to allow bypassing a failed first misting component 241 by use of the second misting component 242. The first misting component 241 may be coupled to the growing unit 220 to provide a mist within the enclosure when the first misting component 241 is in an operative state. Similarly, the second misting component 242 may be coupled to the growing unit 220 to provide a mist within the enclosure when the second misting component 242 is in an operative state. A sensor 250 may be coupled to the growing unit 220 for detecting a failure state of the first misting component 241. A failure state of the first misting component 241 may include, without limitation, any state where the first misting component 241 is not playing an active role in delivering a nutrient mist to the growing unit 220. A switch may be communicatively coupled to the sensor 250 and coupled to the second misting component 242 for switching the second misting component 242 to an operative state upon detection by the sensor 250 of the failure state of the first misting component 241. Once the failure state of the first misting component 241 is resolved, the second misting component 242 may be switched off and the first misting component 241 may be turned on.

In embodiments with more than two misting components, a failure of the second misting component will lead to a switching on of the next misting component.

In some embodiments, the growing unit may include a counter communicatively coupled to each of the first and second misting components and a second switch communicatively coupled to the first and second misting components and to the counter. The switch may be for switching the second misting component to the operative state and the first misting component to a non-operative state after the first misting component has run for a first predetermined number of cycles on the counter and for switching the second misting component to a non-operative state and the first misting component to an operative state after a second predetermined number of cycles on the counter. In certain embodiments, the counter may be a timer and the number of cycles may be based on a length of time.

In some embodiments, the first misting component 241 may be meant to be operative for the entirety of the operational time and the second misting component 242 may be operative only when the first misting component 241 is in a failure state. In certain embodiments, misting operations may be scheduled to be split between both misting components. Any suitable split may be used. For example, the first misting component 241 may operate for 80% of the operating time while the second misting component 242 may operate for the remaining 20% of the time. An advantage of splitting the operational time between the misting components is that the second misting component 242 is run regularly to prove function in the event of failure of the first misting component 241. Splitting operational time may also allow for scheduling maintenance for each of the misting components.

In some embodiments, the first and second misting components 241, 242 may be coupled to a common nutrient reservoir system and to a common nutrient delivery component to form a parallel system as shown in FIG. 2. For example, the misting components may be coupled to the same nozzle. Switching from the first misting component 241 to the second misting component 242 changes the path that the nutrient fluid takes to reach the nozzle. In certain embodiments, each of the misting components may be coupled to its own nutrient delivery component. The first misting component may be coupled to a first nozzle and the second misting component may be coupled to a second nozzle. In some embodiments, each misting component may be coupled to its own respective nutrient reservoir system.

Any suitable types of misting components may be used. In some embodiments, the first and second misting components 241, 242 may be of the same type. In certain embodiments, each of the first and second misting components 241, 242 may be of a different type. For example, the first misting component 241 may be a high pressure pump while the second mist generator 242 may be a low pressure pump. In some embodiments, the second misting component may be a gravity fed sprinkler system. For example, the nutrient reservoir system may be positioned at some height above the growing unit 220 and nutrient fluid may flow down due to gravity to sprinklers for distributing nutrient fluid inside the growing unit 220. A system not using electrical power may be advantageous as a back-up in situations where there might be a loss of power and where power generators might not be feasible. In some embodiments, one of the misting components may be, for example, an ultrasonic transducer or a misting component using pressurized air.

Referring again to FIG. 2, the sensor 250 may be any suitable type of sensor for detecting a failure state of the misting component. For example, in some embodiments, the sensor 250 may comprise a sensor for detecting a mist level within the enclosure, wherein the mist level corresponds to the amount of mist, and the failure state may correspond to a drop in the mist level below a configurable threshold. The sensor may be a humidity or moisture sensor and the configurable threshold may be a moisture level indicative of the lack of a mist within the enclosure. In some embodiments, optical sensors may be used to detect the presence of a mist within the enclosure. Optical sensors may include, for example and without limitation, infrared sensors and lasers for detecting mist concentration levels over time. Optical sensors may also be used to monitor plants to detect a failure state of the misting component. If a misting component is in a failure state, the plants being fed by the mist may begin to show physical signs, such as drooping. Cameras may be used to capture images of the plants and software applications may be used to analyse the images to determine if the plants are suffering from a lack of nutrient mist. Any suitable software application and image analysis techniques may be used.

In some embodiments, the sensor 250 may comprise one or more flow or flow rate sensors. Flow sensors may be coupled to, for example, an inlet or outlet of a misting component where the misting component is a pump, or at any suitable position along the piping leading from the misting component to a nozzle. Flow below a pre-determined or configurable threshold may correspond to a failure state. In certain embodiments, the sensor 250 may comprise one or more pressure sensors. A pressure sensor may be coupled to the outlet of a misting component where the misting component is a pump, or at any suitable position along the piping leading from the misting component to a nozzle. Pressures outside of a pre-determined range of pressures may correspond to a failure state.

In some embodiments, the sensor 250 may be coupled to the first misting component 241 to determine if the first misting component 241 is functional or non-functional. The failure state may correspond to the first misting component 241 being non-functional. For example, a vibrational sensor may be coupled to the first misting component 241. A vibrational reading outside of a pre-determined or configurable range of values may be indicative of the first misting component being non-functional. Similarly, in some embodiments, a pressure sensor or pressure gauge coupled to the first misting component 241, where the first misting component 241 is a pump, may measure pumping pressure and values outside of a pre-determined or configurable range may be indicative of a non-functional pump.

In some embodiments, a non-functional misting component may be indicated by a lack of electrical power to the misting component. In these embodiments, the sensor 250 may be coupled to the misting component and may comprise any suitable sensor for detecting electrical power. For example, current meters, volt meters, or power sensors may be used. A lack of power or current or values below a pre-determined threshold may indicate that the misting component is non-functional.

In some embodiments, the sensor 250 may be communicatively coupled to a processor coupled to a misting component. The processor may perform a diagnostic check of the misting component. Based on the results of the diagnostic check, the misting component may be classified as being in a failure state. For example, if the diagnostic check shows that the misting component is non-operational or operating at a level that will not produce sufficient nutrient mist in the growing unit, the misting component may be classified as being in a failure state. In some embodiments, a failure state may also result if the diagnostic check shows that the misting component should undergo maintenance.

In some embodiments, the sensor 250 may be coupled to a processor and computer storage device. The computer storage device may be integrated with the processor in some embodiments. In certain embodiments, the sensor 250 may be integrated with the processor. In other embodiments, the sensor 250 and the processor may be coupled but not integrated. For example, in some embodiments, the sensor may communicate with a processor at a central computer. Any suitable processor may be used.

Any suitable type of application may be used to analyze the data from the sensor 250. The application may convert raw data from the sensor and compare it with stored values corresponding to different states of operation of the misting component. For example, there may be values corresponding to threshold values indicative of a failure state of the misting component.

In some embodiments, a switch may be used to switch the second misting component on when the first misting component is in a failure state. The switch may be an electrical switch for powering on the second misting component. The switch may be communicatively coupled to the sensor 250. A processor running suitable software may provide instructions for the switch. In some embodiments, the switch may be controlled without a processor. For example, an electrical circuit that switches power to the second misting component when the first misting unit fails may be used.

Mechanical switches, such as flow valves, may also be used in some embodiments. Flow valves, for example, may be used to switch on flow to or from a second misting component. For example, in the case of a gravity fed sprinkler system, a valve may be used to open flow from the nutrient reservoir to the sprinklers. The switch may, in some embodiments, be manually operated.

Referring again to FIG. 1, after a nutrient mist has been delivered to the growing unit 120, excess mist may gather on the roots and interior surfaces of the growing unit 120 as runoff mist. Runoff mist from the growing unit 120 may be captured by the nutrient return system 145. Runoff may drip down from plant roots or walls of the enclosure of the growing unit 120 to a base portion of the enclosure, which may form a part of the nutrient return system 145. Collected runoff may be passed through the nutrient return filtration system 150 for filtering out, for example, plant debris. Bits of root material or plant material may fall into the collected runoff. Additionally, material from the plant receptacles may fall into the collected runoff. The filtration system 150 may filter out debris before the collected runoff passes through a return pump or a sump pump. Any suitable filter may be used, similarly to filters used for the filtration system 135 described above.

In some embodiments, the runoff may also be treated using disinfectant systems such as chlorine treatments and UV light based filters, as described earlier. Additionally, aggressive filtration systems such as, for example, reverse osmosis may also be used. Reverse osmosis may remove all nutrients from the runoff, leaving only water to be returned to the nutrient reservoir system 130. Filtration systems to remove disinfectants may be advantageous for use with plants that are susceptible to disease.

From the nutrient return filtration system 150, the runoff may be passed to a nutrient return treatment system 155. The nutrient return treatment system 155 may comprise sensors including, but not limited to, pH sensors, oxygen sensors, and sensors for determining the amount of nutrients in the nutrient fluid, such as electrical conductivity probes. For example, a sensor for measuring the electrical conductivity of the nutrient fluid may be used. The measurements by the sensor may be compared by an application to known values or ranges of values of conductivity for certain levels of nutrient solute in the nutrient fluid. The nutrient return treatment system 155 may also comprise systems for adding inputs such as, without limitation, water, pH adjusters, and nutrients. In some embodiments, chillers and heaters may also form part of the nutrient return treatment system 155. Runoff treated by the nutrient return treatment system 155 may be returned to the nutrient reservoir system 130.

In some embodiments, runoff may be returned to the nutrient reservoir system 130 without going through a nutrient return treatment system 155. Any changes caused to the nutrient fluid by addition of the runoff may be dealt with through the nutrient conditioning system 125. In certain embodiments, the runoff may be returned to the nutrient reservoir system 130 without being filtered. The runoff may be deposited directly in the nutrient reservoir system 130.

Pumping pressure, or suction, to move the runoff through the nutrient return system 145 may be provided by a pump dedicated to the nutrient return system 145. Any suitable type of pump may be used. In certain embodiments, pumps may not be used in the nutrient runoff system 145. Instead, runoff may flow to the nutrient reservoir system 130 due to gravity.

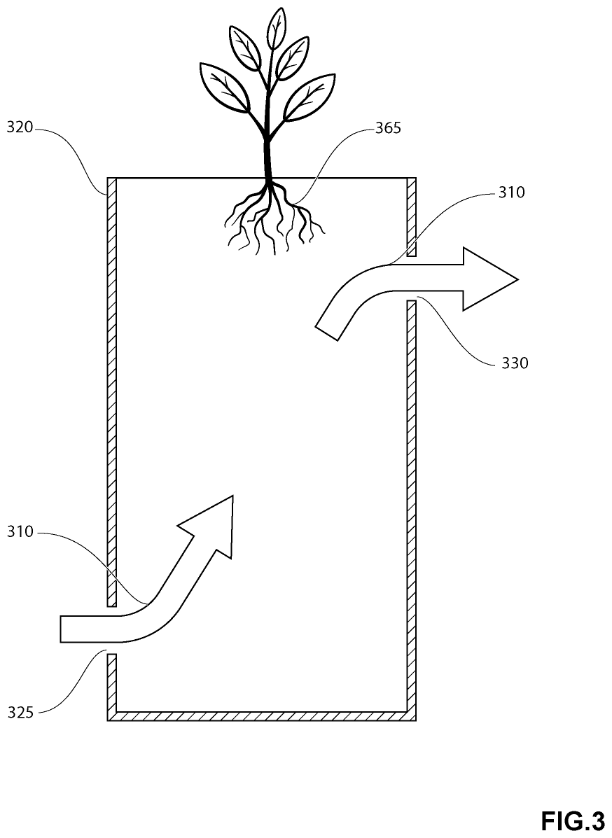

The growing unit is an enclosure. The exterior of the growing unit may be exposed to light for extended periods in order to expose the plants to light. The light may be sunlight or artificial light. Due to the exposure of the growing unit to light, the interior of the growing unit may become warm, as discussed earlier. Additionally, if misting components are inside the growing unit as well, the interior of the growing unit will get even warmer due to heat added by the misting units. As discussed earlier, excess heat may not be conducive to root growth. However, heat may be removed and plant roots cooled using a convection cycle. Referring to FIG. 3, a schematic showing a convection current 310 inside a growing unit 320 is shown in accordance with one embodiment. The convection current forms due to warm air inside the growing unit 320 rising and exiting from the upper opening 330 and cooler air from outside the growing unit 320 entering the interior of the growing unit 320 through a lower opening 325. The convection current cools the interior of the growing unit 320 by having cooler air entering the growing unit 320 and warmer air exiting the growing unit 320. Airflow past the plant roots 365 further assists in cooling the plant roots 365. Airflow may remove heat from the plant roots 365 directly and due to evaporation of fluid on the plant roots 365. Heat may also be removed from mist present in the growing unit 320 as air flows past droplets of fluid nutrient. The cooling effect of the convection current 310 may be further enhanced by having airflow past a pool of nutrient fluid runoff at the bottom of the growing unit 320. As air flows past the runoff, heat may be removed from the runoff and therefore, from the growing unit 320. Evaporation of water from the runoff as air flows past the runoff may create a cooling effect.

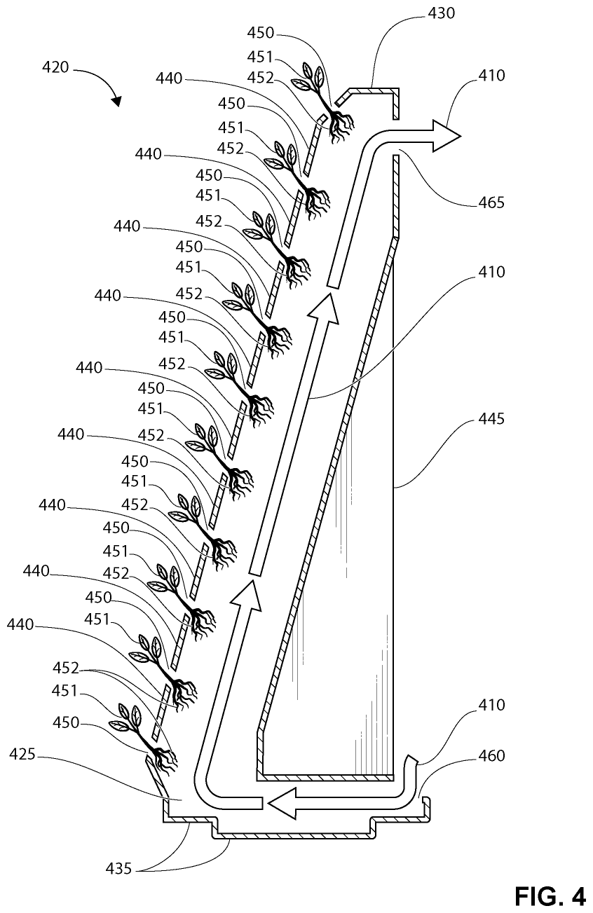

Referring to FIG. 4, another embodiment of a growing unit 420 with a convection current 410 inside the growing unit 420 is shown. The growing unit 420 may be coupleable to a mist generator for delivering a mist within the growing unit 420. The growing unit 420 may include an enclosure 425 formed by two opposing side walls (not shown) connected by a top wall 430, a base 435, a front wall 440 and a back wall 445. The front wall 440 may include one or more plant receptacles 450 for holding plants 451. Each plant receptacle 450 includes an opening for allowing roots 452 of the plant 451 into the enclosure 425. There may be a lower opening 460 in any one of the opposing side walls, the back wall 445, the front wall 440, or the base 435. There may be an upper opening 465 in any one of the opposing side walls, the back wall 445, the front wall 440, or the top wall 430. The lower opening 460 and the upper opening 465 may be shaped and positioned to allow a root cooling convection air current 410 to form between the lower opening 460 and the upper opening 465 to cool plant roots 452 within the enclosure 425 by allowing ambient air to enter the enclosure 425 through the lower opening 460 and warmer air within the enclosure 425 to exit through the upper opening 465. In some aspects of cooling, the growing unit 420 may act similarly to a cooling tower.

In some embodiments, either or both of the lower opening 460 and the upper opening 465 may each comprise a plurality of openings. In certain embodiments, either or both of the lower opening 460 and the upper opening 465 may each be a single opening.

Each of the lower opening 460 and the upper opening 465 may be of any suitable size and shape. In some embodiments, each of the lower opening 460 and the upper opening 465 may extend between the side walls for the full length between the side walls. For example, the lower opening 460 may be a slit or a gap along a bottom portion of the growing unit 420 extending between the side walls. In some embodiments, the upper opening 465 may be one or more circular cutouts on an upper portion of the back wall 445. In certain embodiments, the upper opening 465 may include holes in the top wall 430.

In some embodiments, there may be an air mover coupled to the growing unit 420 at at least one of the lower or upper openings 460, 465. The air mover may be, for example, a fan.

The base 435 of the growing unit 420 may be a sump for holding nutrient solution. The nutrient solution may be runoff from the mist that collects in the sump. In some embodiments, the lower opening 460 may be positioned adjacent to and just above the sump, allowing air to flow past the nutrient solution and thereby enhancing the cooling of the enclosure through evaporative cooling.

The back wall 445 of the growing unit 420 may be positioned perpendicular to the base 435 or at an angle as shown in FIG. 4. In some embodiments, there may be an interior back wall that may slope as shown in FIG. 4 and a back wall 445 that is perpendicular to the base 435. The interior back wall may be positioned between the front wall 440 and the back wall 445 and may have a slope similar to the front wall 440. In certain embodiments, the interior back wall may be parallel or almost parallel to the front wall 440. The interior back wall may be used to limit the space within the enclosure 425 and as an attachment surface for placement of nozzles. Limiting the volume within the enclosure 425 and placing the nozzles closer to the roots 452 may increase the misting efficiency as compared to an enclosure with a larger volume and nozzles spaced farther from the roots 452. The back wall 445 may provide structural support and add stability to the growing unit 420.

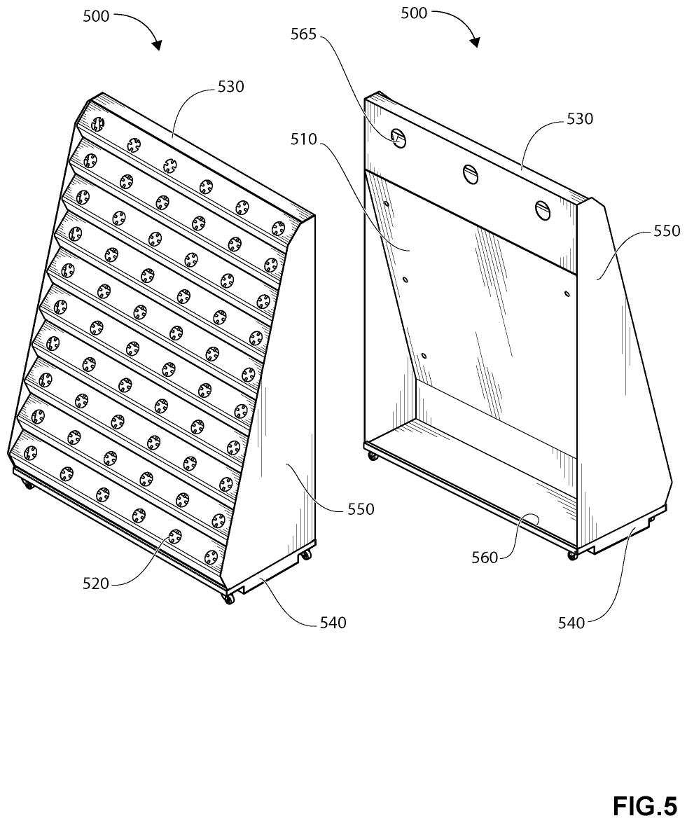

Referring to FIG. 5, a perspective view of an embodiment of a growing unit 500 is shown. The growing unit 500 has a back wall 510, a sloped front wall 520, a top wall, 530, a base 540, and side walls 550. The back wall 510 has a lower opening 560 and upper openings 565 to allow for a convection current inside the growing unit 500. Although not shown, the growing unit 500 may also include an interior back wall, similar to that described above.

The front wall 520 may be sloped towards the back wall 510 such that the intersection of the base 540 and the front wall 520 forms an acute angle. Any suitable acute angle may be used for the slope. In certain embodiments, the slope may be sufficient to allow exposure of the plants on the front wall 520 to light. Having the plants growing out of a sloped surface may limit the shadows cast by plants higher up on the wall on the plants lower on the wall while limiting the floor space used by the growing unit. Growing units with differing slope angles may be used for different lighting conditions and different types of plants. For example, in some embodiments, the front wall 520 may slope towards the back wall 510 with a slope angle at the intersection of the base 540 and the front wall 520 between about 50° and about 85°. In certain embodiments the slope angle at the intersection of the base 540 and the front wall 520 may be about 65°.

In some embodiments, the front wall 520 may be formed of a series of step like projections forming a series of alternating peaks and valleys extending down a sloped plane, as shown in FIG. 5. A top surface of each step like projection may include one or more plant receptacles and be sloped such that a top edge of the top surface is closer to the back wall 510 than a bottom edge of the top surface. In some embodiments, the top surface of each step like projection may be parallel to the base 540.

The bottom surface of each step like projection may bend back towards the back wall 510 or towards the base 540. The top surface and bottom surface may meet at any suitable angle. In some embodiments, the geometry of the step like projections is selected to limit shade from a higher positioned projection on a lower positioned projection and to limit the possibility of higher projections from physically obstructing plants growing on a lower projection. In certain embodiments, the geometry of the step like projections is selected to provide clearance for roots inside the growing unit 500. In some embodiments, a bending angle between a top surface and a bottom surface of a step like projection may be slightly greater than about 90°. The angle selected, however, may be dependent on the overall slope of the front plane and the size of the growing unit.

Having the front wall 520 be formed of a series of step like projections may be advantageous by decreasing the floor space used by the growing unit 500. Using step like projections allows for a steeper slope for the plane that the step like projections extend along (the plane extending from the front edge of the base 540 to the front edge of the top wall 530) and thus a smaller footprint for the base 540 while maintaining a shallower slope for the top surface of each step like projection. In some embodiments, the plane that the step like projections extend along may be vertical or perpendicular to the base 540, further reducing the footprint of the growing unit 500. In certain embodiments, having a non-vertical slope for the plane that the step like projections extend along may be advantageous for increasing the stability of the growing unit 500. A wider base and a lower center of gravity may decrease a risk of a growing unit 500 toppling over. Additionally, having a non-vertical slope allows for receptacle openings that have a perpendicular axis oriented away from the horizontal (the horizontal being defined as parallel to the surface the growing unit is positioned on). Additionally, the non-vertical slope allows for plant receptacles that are staggered in the horizontal plane which limits physical obstructions caused by higher positioned plants to lower positioned plants.

The growing unit may be of any suitable height. In some embodiments, the growing unit may be between about 5 feet and about 8 feet tall. A growing unit with a height between about 5 feet and about 8 feet may be advantageous for having people attend to the plants without the use of ladders. In some embodiments, taller growing units may be used. For example, growing units reaching to a roof of a building may be used. Some growing units may be used in buildings with high ceilings and may be, for example, over 20 feet tall. Similarly, the growing unit may have any suitable width, wherein the width is the horizontal length of the front wall 520.

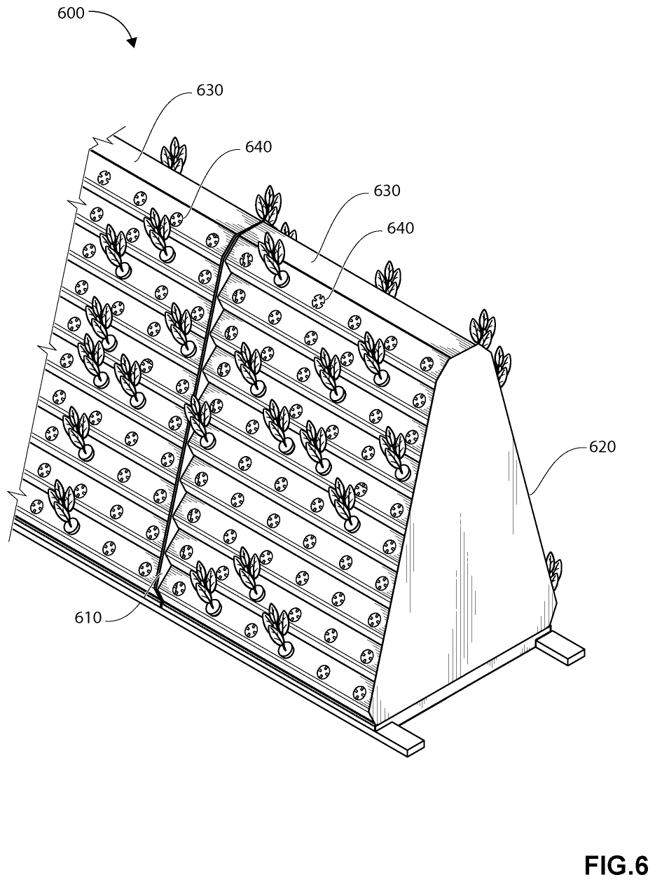

Referring to FIG. 6, an embodiment of an A frame style growing unit 600 is shown. An A frame style growing unit may have a front wall 610 and a back wall 620 that are sloped towards each other. Plant receptacles may be on positioned on both the front and the back walls 610, 620. Lower and upper openings for allowing air to flow into and out of the growing unit 600 may be located along any of the front or back walls 610, 620. In some embodiments, a lower opening may be located on any of the side walls. In certain embodiments, the upper opening 640 may be located on any of the side walls or the top wall 630.

In some embodiments, internal structures within the growing unit 600 may be used for positioning piping and nozzles. Any suitable internal structure may be used. For example, an internal wall running through the middle of the growing unit 600 may have piping and nozzles attached to it. The internal wall may be solid or may have openings in it. In some embodiments, the internal wall may be a mesh wall. In certain embodiments, horizontal or vertical bars or rods may be used for positioning piping and nozzles on. In some embodiments, nozzles may be suspended within the growing unit 600 using, for example and without limitation, wire, cable, string, or any suitable type of line.

Referring again to FIG. 5, in certain embodiments, two growing units 500, each with a sloped front wall 520 and a vertical back wall 510, may be placed back wall 510 to back wall 510 to form an A frame style set-up.

As discussed earlier, using an A frame style set-up permits planting on both sides of the growing unit. This may be advantageous in making efficient use of floor space. Additionally, using an A frame style set-up may allow a user to take advantage of the sun cycle. The growing unit may be positioned with one growing surface (the front or back wall) facing in a westerly direction and the other growing surface facing in an easterly direction. Plants on either side may be exposed to equal amounts of sunlight as the day progresses and the sun moves from east to west relative to the growing unit.

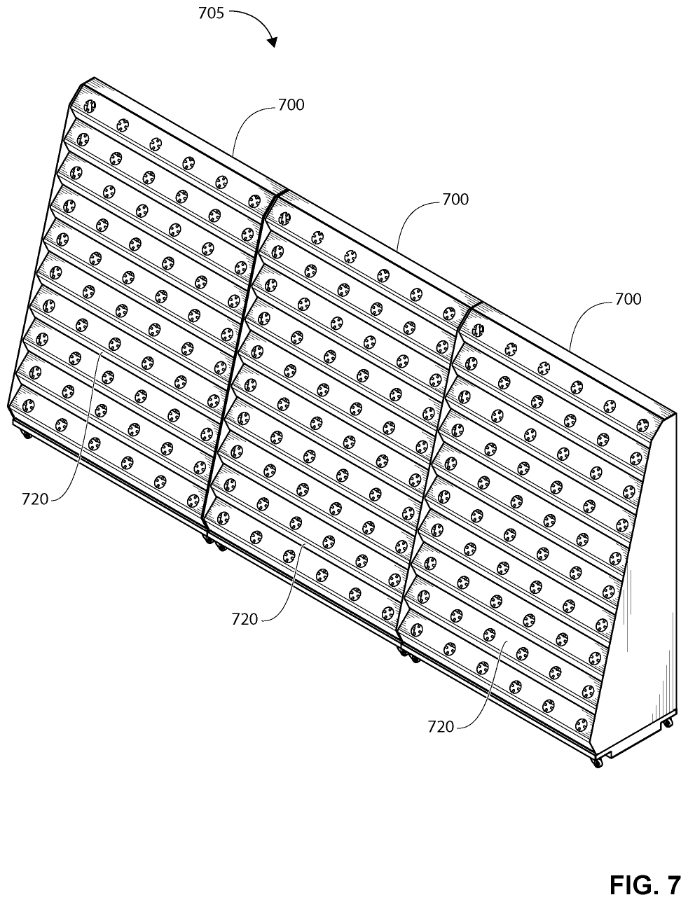

Referring to FIG. 7, there is shown an embodiment of multiple growing units 700 in a daisy-chained configuration 705. The multiple growing units 700 may be daisy chained, side-wall to side-wall with the front wall 720 of each growing unit 700 facing in the same direction. Each growing unit may be served by its own misting generators and nutrient reservoir. In some embodiments, multiple growing units 700 may share a nutrient reservoir. Multiple growing units 700 may also share a misting generator, with piping extending between adjacent growing units 700. In some embodiments, piping may pass through slots in the side walls between adjacent growing units 700. In certain embodiments, a portion of the side walls between adjacent units may be removable.

In some embodiments, all of the growing units 700 in a chain may be of the same size. In certain embodiments, growing units 700 of different sizes may be daisy chained. For example, growing units with different lengths may be daisy chained.

Referring again to FIG. 5, the growing unit 500 may be constructed of any suitable material. For example, in some embodiments, any suitable metallic material may be used. Examples include, without limitation, stainless steel and aluminum compounds. In certain embodiments, polymer materials such as plastics may be used. Any suitable plastic may be used. In some embodiments, composite materials, such as fibreglass and carbon fiber may be used. Coated metals may also be used. For example, and without limitation, painted steel or steel with a rubber coating may be used. In certain embodiments, the growing unit 500 may be constructed of several different materials.

The thickness of the materials used for constructing the growing unit 500 may be any suitable thickness.

Plant receptacles on the front wall 520 of the growing unit 500 may be vertically and horizontally spaced according to any suitable configuration. The configuration may be based on the type of plants being grown. In some configurations, plant receptacles may have a center to center horizontal spacing of about 20 cm and a vertical center to center spacing of about 20 cm.

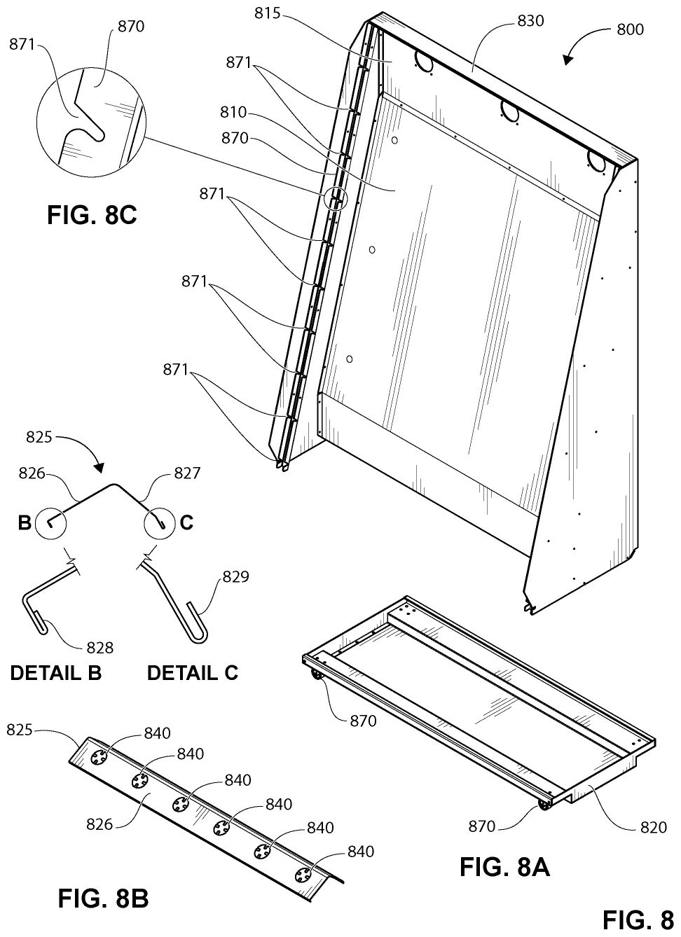

Referring to FIG. 8a, an exploded view of a growing unit 800 is shown in accordance with some embodiments. An interior back wall 810 is in a spaced apart opposing position to a portion of the front wall. The interior back wall 810 meets the back wall 815 near the top of the growing unit 800. At the bottom, the interior back wall 810 bends to the vertical in the embodiment of FIG. 8a. The interior back wall 810 does not reach to the bottom of the growing unit 800. A gap at the bottom, between the interior back wall 810 and the base 820 forms part of a lower opening to allow ambient air from outside the growing unit 800 into the growing unit 800.

The base 820 may be a sump. The base 820 may have any suitable configuration. In the embodiments shown in FIG. 8a, the base 820 has a depressed portion for holding runoff fluid. A misting generator and a return system pump may be positioned in the base 820 in some embodiments. A return system pump pumps runoff fluid to the nutrient return system. In some embodiments, the entire base 820 may be at a single level rather than having elevated and depressed portions.

In some embodiments, the base 820 may have wheels 870 attached to the outside for moving the growing unit 800. In some embodiments, there may be wheels only on a back side or front side of the base 820 to assist in moving the growing unit 800 by tipping and rolling the growing unit 800. In certain embodiments, the base 820 may not have wheels. In some embodiments, wheels may be attachable to the base 820 when desired.

The front wall (not shown) of the growing unit 800 is formed of multiple panels 825. The panels 825 are removable. Each panel may include one or more plant receptacles 840. In the embodiment shown in FIG. 8a, the panels 825 are horizontally oriented with each panel 825 extending the length of the front wall. In some embodiments, the panels 825 may have a vertical orientation.

Each panel 825 shown in FIG. 8a includes a single row of plant receptacles 840. A configuration in which each panel 825 includes only a single row of plant receptacles 840 may be advantageous because a single user may be able to manually lift out the panel 825 and replace it.

In some embodiments, each panel 825 may include multiple rows of plant receptacles 840. In certain embodiments, the entire front wall may comprise a single removable panel 825. In large scale operations, large panels with multiple rows of plant receptacles may be lifted away from the growing unit and replaced using lifting machines, such as overhead cranes.

In some embodiments, the panel 825 may form a single step like projection along a sloped plan extending from a front edge of the base 820 to a front edge of the top wall 830, similar to those discussed above in relation to the embodiment shown in FIG. 5. A top surface 826 of the panel 825 may include one or more plant receptacles. In certain embodiments, the panel 825 may include a plurality of step like projections.

Referring to FIG. 8b, side views of the panel 825 are provided. The panel 825 has a top surface 826 and a bottom surface 827. The top surface includes one or more plant receptacles 890. The top surface 826 and the bottom surface 827 may intersect at any suitable angle. For example, in some embodiments, the top surface 826 and the bottom surface 827 may intersect at an angle between about 90° and about 120°.

Each panel 825 may be held in place along the front of the growing unit 800 using any suitable connection. For example, in some embodiments, a hook portion 828 extending at an angle from the top surface 826 may hook into side rail grooves 871, shown in FIG. 8c, in side rails 870 on an inner side of each side wall of the growing unit 800. The hook portion 828 may also slide into a catch 829 extending from the bottom surface 827 of an adjacent panel, thereby connecting adjacent panels.

In some embodiments, each panel may have a hook portion or a flange on each side that catches or slides into a groove or hole on each side of the growing unit. The grooves or holes may be in side rails coupled to each side of the growing unit. Individual panels may be removable without removing adjacent panels as the panels are not directly joined to each other.

In certain embodiments, magnets may be used to hold the panels in place. In some embodiments, fasteners such as screws and bolts may be used. For example, threaded bolts with heads suitable for manual manipulation without the need for tools may be used to fasten a panel to the growing unit by screwing the bolt through a hole in the panel and into a threaded hole in the growing unit.

Having modular panels that may be added or removed may be advantageous in allowing a user to remove a panel for attending to plants away from the growing unit or for adding plants to or removing plants from plant receptacles. Modular panels also allow selective access to the interior of the growing unit. For example, a panel near the top may be moved to access nozzles near the top instead of moving the entire front or back. Additionally, panels with different types of plant receptacles may be used as desired by a user. For example, one panel may have larger plant receptacles and a second panel may have smaller plant receptacles.

An additional advantage of using a modular system is stackability of components of the growing unit for storage or moving. Panels may be stacked upon each other. In some embodiments, side walls may also be removable, allowing them to be stacked onto each other. Either the base or the top wall, or both, may also be removable. The various components may be shaped to stack onto each other, allowing multiple components of the same type to be stacked onto each other. Stacking components of the growing unit for storage or moving may save space as compared to non-modular, fully assembled growing units, thereby allowing for increased efficiency during storage or moving of multiple growing units.

In some embodiments, each of the panel, the opposing side walls, and the base may be modularly coupled to and manually removable from the top wall and the back wall. Modularly coupled and manually removable means, for the purposes of the present disclosure, that these components may be coupled and removed without the use of hand tools or power tools. The panel may be shaped for stacking with a second panel, the opposing side walls may be shaped for stacking with second opposing side walls, the base may be shaped for stacking with a second base and the combination of the top wall and the back wall may be shaped for stacking with a second combination of a second top wall and a second back wall.

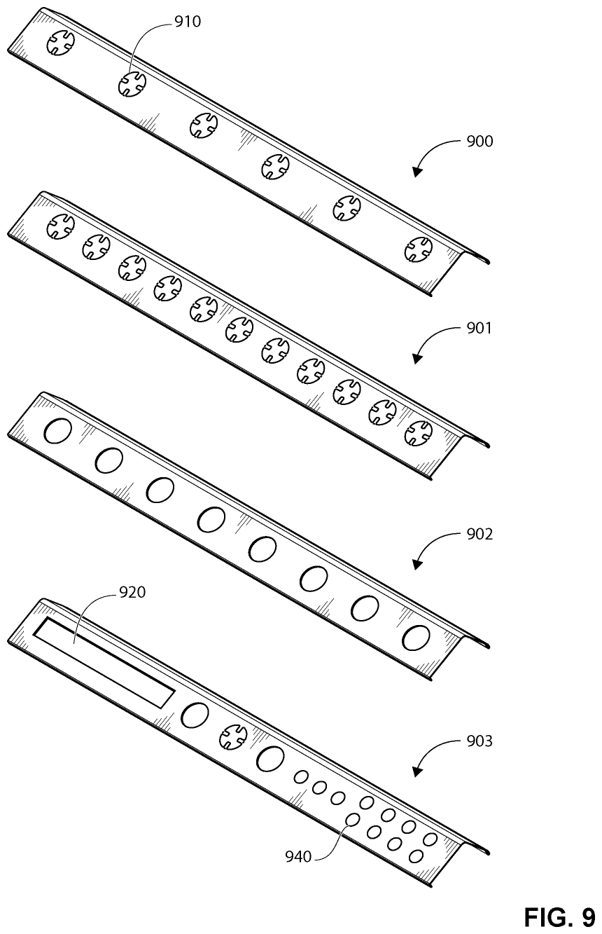

Referring to FIG. 9, examples of panels 900, 901, 902, 903 with different plant receptacles are shown. Panels may include different numbers of plant receptacles and different types of plant receptacles. Some panels may include a variety of plant receptacles on a single panel.

Any suitable shape and size of plant receptacle may be used. Some embodiments may include plant receptacles for single plants, such as the plant receptacle shown at 910. Other plant receptacles, such as large rectangular shaped plant receptacles 920, may be used to hold a container for multiple small plants, such as microgreens like wheat grass. Single seed plant receptacles 940 may allow single seeds to be planted in some containers.

Any suitable type of plant receptacle may be used. In some embodiments, the plant receptacle may be an opening for holding a container or. In some cases, extensions may project from the edge of the opening to hold the container. Extensions or clips may also be used to hold a material holding a seed or plant. For example, a seed may be held in a sponge and held by clips in the plant receptacle. In some case, a plug containing a seed or a plant may be held by extensions or clips. Clips may also be used to hold a plant stem in a plant receptacle. In certain embodiments, the plant receptacle may be a container with openings. For example, the plant receptacle may have walls extending into the growing unit and a mesh bottom. Other types of openings may include slits and multiple holes cut or punched out of an otherwise solid bottom.

Plants or seeds may be held in net or mesh containers, which in turn are held at the plant receptacles. Any suitable method or system for the holding the net container at the plant receptacle may be used. The net container may have an edge that overlaps an edge of the plant receptacle to hold the net container in place. In some embodiments, the net container may be held in position using a friction fit. In certain embodiments, a smaller net container may be held by extensions extending from the edge of the plant receptacle. In addition to a plant or a seed, net containers may hold pellets, such as clay pellets, stones, polymer plugs (such as neoprene plugs). In some cases, a container may have the bottom removed and a plant may be held by a plug friction fit into the container.

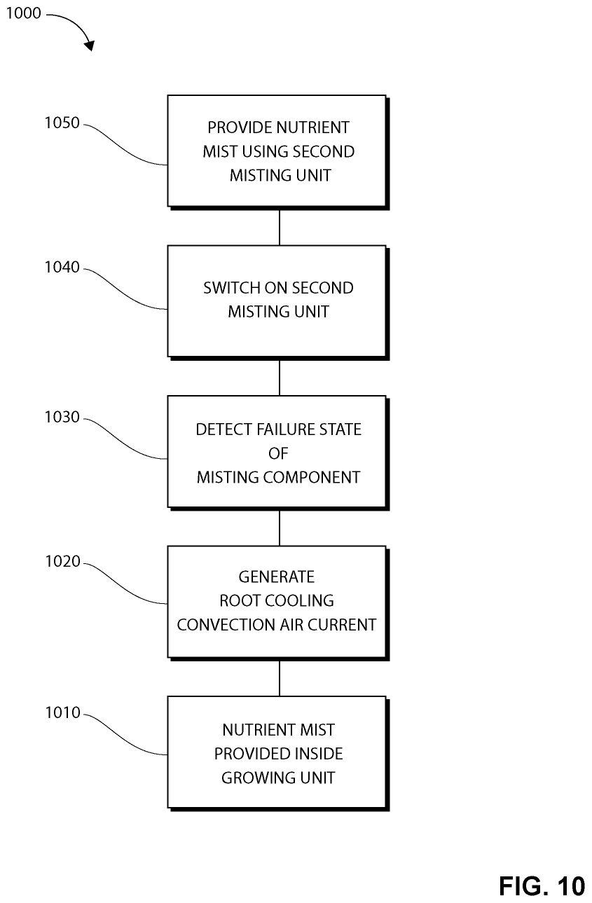

Referring to FIG. 10, an embodiment of a method 1000 for growing a plant in an aeroponics growing unit is shown. At box 1010, a nutrient mist may be provided inside the growing unit using a first misting component coupled to the growing system to provide nutrients and water to roots of the plant extending inside the growing unit. The inside of the growing unit may be an enclosure formed by a base, a back wall, a front wall, a top wall, and opposing side walls of the growing unit, as described above.

At box 1020, a root cooling convection air current may be generated between a lower opening and an upper opening to cool plant roots within the enclosure by allowing ambient air to enter the enclosure through the lower opening and warmer air within the enclosure to exit through the upper opening. The lower opening may be positioned in any one of the opposing side walls, the back wall, the front wall, or the base and the upper opening may be positioned in any one of the opposing side walls, the back wall, the front wall, or the top wall. The lower opening and the upper opening may be shaped and positioned to generate the root cooling convection air current as described earlier.

At box 1030, a sensor may be used to sense a failure state of the first misting component. Any suitable sensor may be used, as described earlier. For example, a sensor for detecting a mist level, such as, without limitation, a humidity sensor or an optical sensor, may be used to detect if the mist level in the aeroponics growing unit falls below a threshold mist level, wherein the threshold mist level corresponds to a failure state. In some embodiments, sensing a failure state may include capturing an image of the plant using a camera and determining that the plant exhibits characteristics corresponding to a lack of nutrient mist using image analysis software. Sensing a lack of power to the first misting component or a drop in pumping pressure may also be indicative of a failure state in some embodiments.

At box 1040, a second misting component may be switched to an operative state using a switch communicatively coupled to the sensor and to the second misting component upon detection by the sensor of the failure state of the first misting component. At box 1050, the second misting component provides a mist inside the growing unit.

In some embodiments, the first and second misting components may normally be run on a schedule where each is run for a certain period of time. For example, the first misting component may be run 80% of the time and the second misting component may be run 20% of the time. By using the second misting component on a regular but limited basis, may provide a user with regular confirmation that the second misting component is operable in case of a failure of the first misting component. Any problems with the second misting component may be detected by running the second misting component on a regular basis.

### Testing

Tests of a growing unit based on the present disclosure have shown healthy plant and root growth at ambient air temperatures (temperatures outside the growing unit) above 30° C. Various types of plants have been grown, including, without limitation, kale, strawberries, lettuce, mint, basil, tomatoes, bok choy, geraniums, and wasabi. All of these plants have shown healthy root growth with fractal root branching, which increases root surface area, including at ambient air temperatures above 30° C.

According to the literature, including Sumarni, Suhardiyanto, Seminar, and Saptomo, Temperature Distribution in Aeroponics System with Root Zone Cooling for the Production of Potato Seed in Tropical Lowland, International Journal of Scientific & Engineering Research, Volume 4, Issue 6, June-2013, ISSN 2229-5518 and Tse and Ruth, Chilling The Root Zone, Practical Hydroponics and Greenhouses—Issue 91, December 2006, the optimal root zone temperature is between 10° C. and 25° C. Plants have failed to grow at higher temperatures. The apparatus and methods of the present disclosure, however, have allowed for healthy plant growth at temperatures above 25° C.

The terminology used herein is for the purpose of describing particular embodiments only and is not intended to be limiting. Accordingly, as used herein, the singular forms “a”, “an” and “the” are intended to include the plural forms as well, unless the context clearly indicates otherwise. It will be further understood that the terms “comprises” and “comprising,” when used in this specification, specify the presence of one or more stated features, integers, steps, operations, elements, and components, but do not preclude the presence or addition of one or more other features, integers, steps, operations, elements, components, and groups.

It is contemplated that any part of any aspect or embodiment discussed in this specification can be implemented or combined with any part of any other aspect or embodiment discussed in this specification.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A growing unit coupleable to a mist generator for delivering a mist within the growing unit, the growing unit comprising:
(a) an enclosure formed by two opposing side walls connected by a top wall, a base, a front wall and a back wall;
(b) a plant receptacle in the front wall for holding a plant, wherein the plant receptacle comprises an opening for allowing a bottom portion of a stem of the plant and roots of the plant into the enclosure; and
(c) a lower opening in any one of the opposing side walls, the back wall, the front wall, or the base and an upper opening in any one of the opposing side walls, the back wall, the front wall, or the top wall wherein the lower opening and the upper opening are shaped and positioned to allow a root cooling convection air current to form between the lower opening and the upper opening to cool plant roots within the enclosure by allowing ambient air to enter the enclosure through the lower opening and warmer air within the enclosure to exit through the upper opening.

2. The growing unit of claim 1 wherein the lower opening comprises a plurality of openings, and wherein the upper opening comprises a plurality of openings.

3. (canceled)

4. The growing unit of claim 1 wherein the lower opening extends between the side walls for a length equal to the length between the side walls.

5. The growing unit of claim 1 wherein the base comprises a sump for holding a nutrient solution.

6. The growing unit of claim 1 wherein the front wall is sloped towards the back wall.

7. The growing unit of claim 1 wherein the front wall comprises a plurality of panels.

8. The growing unit of claim 1 wherein the front wall comprises a plurality of step like projections staggered along a sloped plane from a front edge of the base to a front edge of the top wall.

9. The growing unit of claim 1 further comprising an air mover coupled to the enclosure at least one of the lower or upper openings wherein if the air mover is coupled to the lower opening, the air mover is positioned to move air into the growing unit and if the air mover is coupled to the upper opening, the air mover is positioned to move air out of the growing unit, and
wherein each of the panel, the opposing side walls, and the base are modularly coupled to and manually removable from the top wall and the back wall and wherein the panel is shaped for stacking with a second panel, the opposing side walls are shaped for stacking with second opposing side walls, the base is shaped for stacking with a second base and the combination of the top wall and the back wall is shaped for stacking with a second combination of a second top wall and a second back wall.

10. (canceled)

11. A plant growing system comprising:
(a) a growing unit comprising an enclosure formed by two opposing side walls connected by opposing front and back walls, a top wall, and a base;
(b) a first misting component coupled to the growing unit to provide a mist within the enclosure when the first misting component is in an operative state;
(c) a second misting component coupled to the growing unit to provide a mist within the enclosure when the second misting component is in an operative state;
(d) a sensor coupled to the growing unit for detecting a failure state of the first misting component; and
(e) a switch communicatively coupled to the sensor and coupled to the second misting component for switching the second misting component to an operative state upon detection by the sensor of the failure state of the first misting component.

12. The plant growing system of claim 11 further comprising a counter communicatively coupled to each of the first and second misting components and a second switch communicatively coupled to the first and second misting components and to the counter, wherein the switch is for switching the second misting component to the operative state and the first misting component to a non-operative state after the first misting component has run for a first predetermined number of cycles on the counter and for switching the second misting component to a non-operative state and the first misting component to an operative state after a second predetermined number of cycles on the counter.

13. The plant growing system of claim 11 wherein the growing unit further comprises:
(a) a plant receptacle in the front wall for holding a plant, wherein the plant receptacle comprises an opening for allowing a bottom portion of a stem of the plant and roots of the plant into the enclosure; and
(b) a lower opening in any one of the opposing side walls, the back wall, the front wall, or the bottom wall and an upper opening in any one of the opposing side walls, the back wall, the front wall, or the top wall wherein the lower opening and the upper opening are shaped and positioned to allow a root cooling convection air current to form between the lower opening and the upper opening to cool plant roots within the enclosure by allowing ambient air to enter the enclosure through the lower opening and warmer air within the enclosure to exit through the upper opening.

14. The plant growing system of claim 11 wherein the sensor measures mist level within the enclosure and the failure state corresponds to a drop in the mist level below a configurable threshold.

15. The plant growing system of claim 11 wherein the sensor is coupled to the first misting component to determine if the first misting component is functional or non-functional and wherein the failure state corresponds to the first misting component being non-functional.

16. The plant growing system of claim 11 wherein the sensor determines if the first misting component is functional or non-functional based on whether the first misting component is powered on or not.

17. The plant growing system of claim 11 wherein the sensor comprises a pressure sensor and determines if the first misting component is functional or non-functional based on pumping pressure.

18. The plant growing system of claim 11 wherein the sensor is communicatively coupled to a processor of the first misting component and determines if the first misting component is functional or non-functional based on a diagnostic check by the processor.

19. The plant growing system of claim 13 wherein the sensor is a camera for capturing an image of the plant and an image analysis application determines if the first misting component is functional or non-functional based on an analysis of the plant's appearance.

20. A method for growing a plant in an aeroponics growing unit, the method comprising:
(a) providing a nutrient solution mist inside the aeroponics growing unit using a first misting component coupled to the aeroponics growing unit to provide nutrients and water to roots of the plant extending inside the aeroponics growing unit, wherein the inside of the aeroponics growing unit is an enclosure formed by a base, a back wall, a front wall, a top wall, and opposing side walls of the aeroponics growing unit;
(b) generating a root cooling convection air current between a lower opening and an upper opening to cool plant roots within the enclosure by allowing ambient air to enter the enclosure through the lower opening and warmer air within the enclosure to exit through the upper opening, wherein the lower opening is positioned in any one of the opposing side walls, the back wall, the front wall, or the base and the upper opening is positioned in any one of the opposing side walls, the back wall, the front wall, or the top wall and wherein the lower opening and the upper opening are shaped and positioned to generate the root cooling convection air current.

21. The method of claim 20 further comprising:
(a) sensing a failure state of the first misting component using a sensor coupled to the aeroponics growing unit;
(b) switching a second misting component to an operative state using a switch communicatively coupled to the sensor and to the second misting component upon detection by the sensor of the failure state of the first misting component; and
(c) providing a mist inside the aeroponics growing unit using the second misting unit.

22. (canceled)

23. The method of claim 21 wherein sensing a failure state comprises:
(a) capturing an image of the plant using a camera; and
(b) determining that the plant exhibits characteristics corresponding to a lack of nutrient mist using image analysis software;
or
sensing a mist level in the aeroponics growing unit that is below a threshold mist level.
